(19) United States
(12) Patent Application Publication
(10) Pub. No.: US 2006/0187547 A1
(43) Pub. Date: Aug. 24, 2006

(54) Polarized light irradiation apparatus polarized light irradiation method, photo alignment film, and retardation film

(76) Inventor: Masanori Fukuda, Tokyo (JP)

Correspondence Address: SEYFARTH SHAW LLP, 55 E. MONROE STREET, SUITE 4200, CHICAGO, IL, 60603-5803, US

(21) Appl. No.: 11/336,352

(22) Filed: Jan. 20, 2006

(30) Foreign Application Priority Data
Jan. 21, 2005 (JP) 2005-013845

(51) Int. Cl. G02B 27/28; G02B 5/30

(52) U.S. Cl. 359/485

(57) ABSTRACT

The main object of the invention is to provide a polarized light irradiation apparatus capable of providing a uniform alignment ability for an alignment film without using a highly parallelized light, and capable of conducting a photo-alignment in a larger area efficiently, and having an excellent durability. To this end, there is proposed a polarized light irradiation apparatus comprising: a light source; a projection device for projecting a light from the light source as a projection light including a non-parallel light; a polarizer for passing the projection light therethrough and comprising one glass plate disposed at a tilt by Brewster angle relative to an incident direction of a center part of the projection light, or comprising a plurality of glass plates disposed in parallel with each other at a predetermined interval and at a tilt by Brewster angle relative to the incident direction of the center part of the projection light; and a substrate transportation device for transporting an irradiation target substrate in a direction perpendicular to a straight line including a projection image which is obtained by projecting an incident plane of a light entering at the Brewster angle among the projection light onto the substrate.

### BACKGROUND OF THE INVENTION

1. Field of the Invention

The present invention relates to a polarized light irradiation apparatus and a polarized irradiation method suitably used for photo-aligning an alignment film of a liquid crystal display device by irradiating such a film with polarized light. The present invention further relates to a photo alignment film and a retardation film produced by using such apparatus and method.

2. Description of the Related Art

A liquid crystal display device is typically constructed from two substrates. On one of these two substrates, there are provided with a drive device (e.g. thin film transistor known as TFT), an electrode made of a transparent conductive film for driving a liquid crystal, and an alignment film for aligning a liquid crystal in a specific direction, and so on. On the other substrate, there are provided with a light shielding film referred to as “black matrix”, a color filter (in the case of a color liquid crystal display device), and the above-mentioned alignment film. Alignment films of these two substrates act to align molecules of a liquid crystal sandwiched therebetween in a specific direction.

On the other hand, as a method of improving a view angle of a liquid crystal display device, there is known a method of inserting a retardation film for an optical compensation between a polarizing plate and a liquid crystal display device. Such a retardation film may be produced by a method of applying a liquid crystal material onto an alignment film provided with an alignment ability, so as to align the liquid crystal material in a predetermined manner, and thereby providing birefringence property for the film.

In order to provide such an alignment ability for these alignment films, there is known a rubbing process of rubbing a surface of the film with a cloth wound around a rotatable roller. In such a rubbing process, however, there are several inherent problems such as a generation of static electricity due to triboelectrification, and a generation of dust from cloths or the like. Therefore, a development is required for a method of aligning liquid crystal molecules without using the rubbing process. Thus, various approaches are proposed.

In order to align the liquid crystal molecules, there are several methods of forming an alignment film based on photodimerization, photolysis, or photoisomerization, for example. For example, M. Schadt et al., JPN.J. Appl. Phys., 31, p2155-2164 (1992) discloses a method of controlling a cross-linking formation direction of a polyvinyl cinnamate alignment film by irradiating the film with polarized ultraviolet light. Furthermore, M. Nishikawa et al., Liquid Crystals, 26, p575-580 (1990) disclosed a method of providing anisotropy for a decomposition of polyimide alignment film by irradiating the film with (polarized) ultraviolet light.

As materials for generating the polarized ultraviolet light used to form the alignment film by the above-mentioned photodimerization, photolysis or photoisomerization, there are known a prism polarizer, and a polarizing film using a material exhibiting its dichroism in an ultraviolet range. Furthermore, Japanese Patent Application Laid-open No. Hei 10-90684 discloses a polarizer comprising a plurality of glass plates which are disposed in parallel with each other at a predetermined interval and at a tilt by Brewster angle relative to main beam.

However, the above-mentioned prism polarizer is difficult to obtain itself in a large size and thereby difficult to obtain polarized light in a large area. Also, the above-mentioned polarizing film using a material exhibiting its dichroism in an ultraviolet range has a problem of durability due to exothermic heat or deterioration involved in light absorption from an ultraviolet light source. Furthermore, in a system using the polarizer based on Brewster angle, there is a problem of divergence of polarization axes in the case of divergent beam, because a polarizing direction depends on an incident angle of an incident light. Therefore, in order to obtain a uniform distribution of the polarization axes in a large area, a highly parallelized light needs to be entered in the polarizer. In order to generate a highly parallelized light for a large area, a large-scale apparatus is required. Additionally, there is a limit to obtain a large area. Therefore, there is a need for a device capable of providing an alignment ability to an alignment film without using a highly parallelized light.

### SUMMARY OF THE INVENTION

The present invention has been accomplished in view of the above problems. It is therefore a main object of the present invention to provide a polarized light irradiation apparatus and method capable of, without using a highly parallelized light, providing a uniform alignment ability to an alignment film, and capable of carrying out a photo-alignment in a large area efficiently, and having an excellent durability.

The inventor has been dedicated to studying a polarization axis of a polarized light for radiation and an alignment angle of a liquid crystal. In result, the inventor found that the distribution of the polarization axes 10 (a direction of a projection image of an incident plane of the light beam) in a case that a kind of light diverging to a certain extent enters a polarizer utilizing Brewster angle is symmetric relative to a straight line 11 including a projection image, which is obtained by projecting an incident plane of the light entering at Brewster angle onto a substrate as shown in FIG. 4. Noting this, the inventor found that the polarization axes can be aligned in a direction of the projection image, which is obtained by projecting the incident plane of the light entering at Brewster angle (i.e. a center of a range in which the polarization axes diverge) onto the substrate, when an alignment film is irradiated with a polarized light while the alignment film is transported in a direction 12 perpendicular to the straight line 11 which includes the projection images and becomes the symmetry axis. Thus, the present invention has been accomplished.

The present invention solves the above problems by providing a polarized light irradiation apparatus comprising: a light source; a projection device for projecting a light from the light source as a projection light including a non-parallel light; a polarizer for passing the projection light therethrough and comprising one glass plate disposed at a tilt by Brewster angle relative to an incident direction of a center part of the projection light, or comprising a plurality of glass plates disposed in parallel with each other at a predetermined interval and at a tilt by Brewster angle relative to the incident direction of the center part of the projection light; and a substrate transportation device for transporting an irradiation target substrate in a direction perpendicular to a straight line including a projection image which is obtained by projecting an incident plane of a light entering at the Brewster angle among the projection light onto the substrate.

According to the present invention, since it is provided with the substrate transportation device for transporting the irradiation target substrate in a direction perpendicular to the straight line including the projection image, onto the substrate, of the incident plane of the light entering at Brewster angle, it is possible to provide the alignment ability for the alignment film uniformly, and conduct the photo-alignment of the film in a large area efficiently, even if using the polarized light having the symmetrically diverged polarization axes and obtained by passing the projection light including a non-parallel light through the polarizer comprising plates disposed in parallel with each other and at a tilt by Brewster angle. Also, since the polarizer used in the present invention is constituted from one or more glass plates, it has an excellent durability.

In the present invention, preferably, there is further provided with a control device for controlling conditions including an illuminance and a transportation speed at least, in order to substantially equalize an accumulated irradiation dose during a prior irradiation with an accumulated irradiation dose during a posterior irradiation at any point in an irradiation target region on the irradiation target substrate, provided that the prior irradiation refers to an irradiation before reaching the straight line including the projection image onto the substrate and the posterior irradiation refers to an irradiation after reaching the straight line. The alignment direction of the alignment film depends on the direction of the polarization axis. However, the irradiation in this embodiment is conducted in such a manner that, for example at a point on the substrate to be transported, the polarized light having the polarization axis at an angle of −x degree relative to the straight line including the projection image onto the substrate during the prior irradiation is counterbalanced with the polarized light having the polarization axis at an angle of +x degree relative to the straight line including the projection image onto the subject during the posterior irradiation. Thereby, it is possible to generally direct the alignment direction of the alignment film in a direction of the projection image onto the substrate of the incident plane of the light entering at Brewster angle (i.e. the center of the range in which the polarization axes diverge). As the result, the deviation of the alignment direction of the alignment film becomes narrow.

Also, in the present invention, preferably, the irradiation target substrate is irradiated at a constant illuminance and is transported almost at a constant speed. Because, in this case, it is relatively easy to almost equalize the accumulated irradiation dose during the prior irradiation with the accumulated irradiation dose during the posterior irradiation at any point, provided that the prior irradiation refers to an irradiation before reaching the straight line including the projection image onto the substrate, and the posterior irradiation refers to an irradiation after reaching the straight line.

In the present invention, the irradiation target substrate may have an long continuous shape. Because, it is possible to form a uniform alignment film suitably even onto the long continuous substrate, by appropriately selecting the substrate transportation device. For example, it is possible to obtain a retardation film having the alignment film and a retardation layer obtained by aligning the liquid crystal material on the long continuous substrate.

The present invention also solves the above problems, by providing a polarized light irradiation method comprising:

a) a process of preparing a light source;

b) a process of preparing a projection device for projecting a light from the light source as a projection light including a non-parallel light;

c) a process of preparing a polarizer for passing the projection light therethrough and comprising one glass plate disposed at a tilt by Brewster angle relative to an incident direction of a center part of the projection light, or comprising a plurality of glass plates disposed in parallel with each other at a predetermined interval and at a tilt by Brewster angle relative to the incident direction of the center part of the projection light;

d) a process of preparing an irradiation target substrate; and

e) a process of irradiating the irradiation target substrate with a polarized light obtained by passing the projection light through the polarizer, while the subject as the irradiation target is transported in a direction perpendicular to a straight line including a projection image which is obtained by projecting an incident plane of a light entering at the Brewster angle among the projection light onto the substrate. According to the present invention, since there is provided with the process of irradiating the irradiation target substrate with the polarized light obtained by passing the projection light through the polarizer, while the irradiation target substrate is transported in a direction perpendicular to the straight line including the projection image which is obtained by projecting the incident plane of the light entering at the Brewster angle onto the substrate, it is possible to provide the alignment ability for the alignment film, even if using the polarized light having the symmetrically diverged polarization axes obtained by passing the projection light including a non-parallel light through the polarizer comprising plates disposed in parallel with each other and at a tilt by Brewster angle.

Furthermore, the present invention provides a photo alignment film produced by means of the polarized light irradiation apparatus or method according to the present invention mentioned above. The photo alignment film of the present invention is advantageous in view of process in that it has inherently no problem involved in the rubbing process such as a generation of static electricity due to triboelectrification or a generation of dust from cloths or the like, and it can be provided with a uniform alignment ability without using a highly parallelized light.

Also, the present invention provides a retardation film produced by means of the polarized light irradiation apparatus or method according to the present invention mentioned above. The retardation film of the present invention is advantageous in view of process in that it has inherently no problem involved in the rubbing process such as a generation of static electricity due to triboelectrification or a generation of dust from cloths or the like, and it can be uniformly aligned and thereby have a uniform optical property without using a highly parallelized light.

### BRIEF DESCRIPTION OF THE DRAWINGS

FIG. 1 is a schematic diagram illustrating an example of the polarized light irradiation apparatus of the present invention.

FIG. 2 is a schematic diagram illustrating an example of the polarized light irradiation apparatus of the present invention.

FIG. 3 is a view for explaining the polarizer used in the present invention.

FIG. 4 is a view for illustrating a polarization axis of a polarized light obtained by entering a divergent light into the polarizer.

FIG. 5 is a view for explaining an polarized light irradiation zone and a polarized light irradiation position on a substrate.

FIG. 6 is a schematic sectional view illustrating an example of the retardation film of the present invention.

In the drawings, 1 refers to a light source, 2 refers to a device for projecting a light from the light source, 3 refers to a polarizer, 4 refers to an irradiation target substrate, 5 refers to a device for transporting the substrate, 6 refers to movement, 7 refers to a projection light including a non-parallel light, 7a refers to a center part of the projection light, 8 refers to an incident plane of a light entering at Brewster angle, 9 refers to a projection image which is obtained by projecting the incident plane of the light entering at Brewster angle onto the substrate, 10 refers to polarization axes, 11 refers to a straight line including the projection image of the incident plane of the light entering at Brewster angle, onto the substrate, 12 refers to a direction perpendicular to the straight line including the projection image of the incident plane of the light generating the Brewster angle onto the substrate, 13 refers to an edge of a portion of the substrate as an irradiation target where an alignment ability is to be provided, 14 refers to a region where the polarized light can be applied, 15 refers to the uppermost stream of the region where the polarized light can be applied, 20 refers to a retardation film, 21 refers to a substrate made of resin, 22 refers to an alignment film, and 23 refers to a retardation layer.

### DETAILED DESCRIPTION OF THE PREFERRED EMBODIMENTS

The present invention includes the polarized light irradiation apparatus and method, the photo alignment film and the retardation film. Each invention will now be discussed in detail.

In the present invention, “light” means an active light beam including ultraviolet ray, visible ray, X ray and so on.

A. Polarized Light Irradiation Apparatus

First of all, an explanation will be made on the polarized light irradiation apparatus of the present invention.

The polarized light irradiation apparatus of the present invention is provided with: a light source; a projection device for projecting a light from the light source as a projection light including a non-parallel light; a polarizer for passing the projection light therethrough and comprising only one plate disposed at a tilt by Brewster angle relative to an incident direction of a center part of the projection light or comprising a plurality of glass plates disposed in parallel with each other at a predetermined interval and at a tilt by Brewster angle relative to an incident direction of a center part of the projection light; and a substrate transportation device for transporting the substrate as an irradiation target in a direction perpendicular to a straight line including a projection image which is obtained by projecting an incident plane of a light entering at the Brewster angle among the projection light onto the substrate.

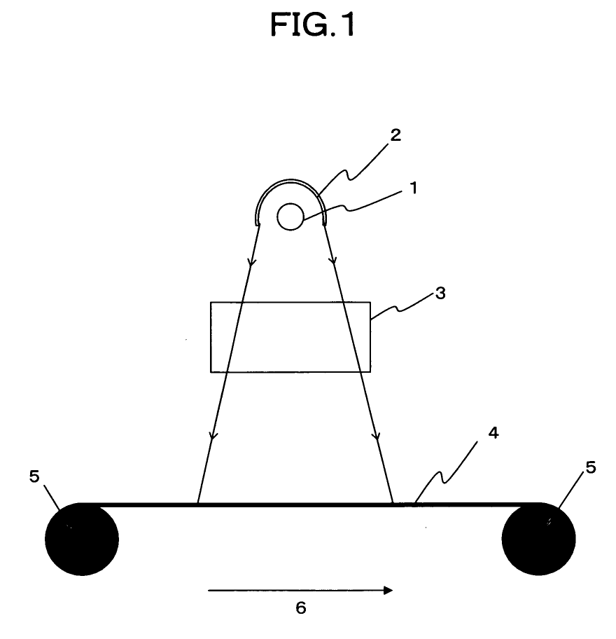

FIG. 1 illustrates an example of the construction of the polarized light irradiation apparatus according to the present invention. The polarized light irradiation apparatus is provided with: a light source 1; a projection device 2 for projecting a light from the light source as a projection light including a non-parallel light; a polarizer 3; and a substrate transportation device 5 for a movement 6 of a substrate 4 to be irradiated.

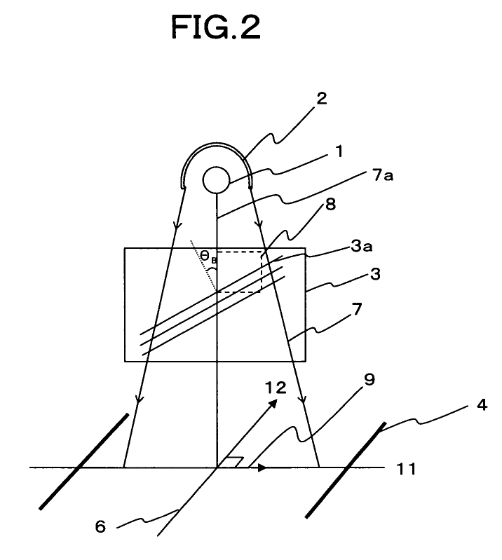

FIG. 2 illustrates the polarized light irradiation apparatus shown in FIG. 1 from the upstream of a movement 6 direction. In the figure, the substrate transportation device is omitted to be shown. In the polarized light irradiation apparatus of the present invention, the light beam projected from the light source 1 via the projection device 2 is a projection light 7 including a non-parallel light. The projection light including a non-parallel light in the present invention means a light whose projection image projected in a certain direction is a spot and which extends in a certain range, so that it differs from a diffusion light or a parallel light.

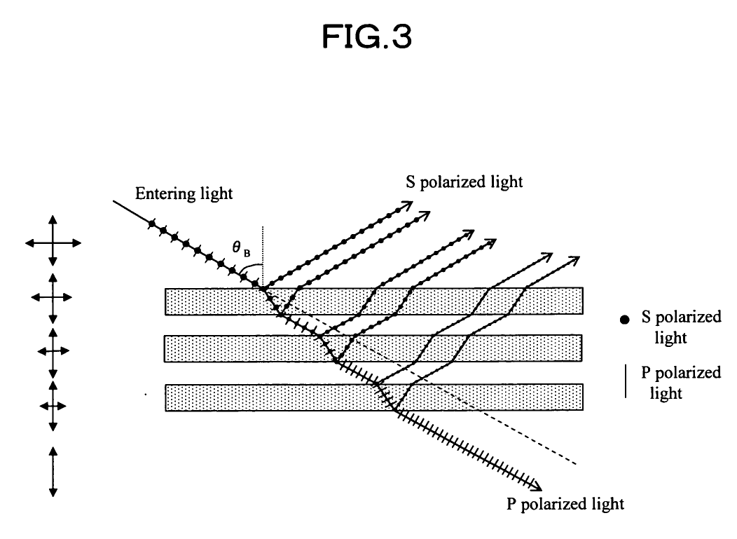

Under a condition that a center part of the projection light 7 including a non-parallel light carries the reference numeral 7a, the polarizer 3 in the light irradiation apparatus of the present invention comprises a plurality of glass plates 3a, as shown in FIG. 3, which are disposed in parallel with each other at a predetermined interval and at a tilt by Brewster angle (θ_{B}) relative to an incident direction of the center part 7a. In the case that the glass plates 3a are disposed at a tilt by Brewster angle (θ_{B}) relative to the incident direction of the center part 7a, the light entering exactly at Brewster angle is only a part of the whole light beam at the center part 7a. For this reason, the light entering exactly at Brewster angle is referred to as “the light entering at Brewster angle”. Usually, two or more glass plates are disposed in parallel with each other. However, it is possible to use only one glass plate, if a sufficient extinction ratio can be obtained with only one plate for an intended application.

Once the parallel light enters the glass plate disposed at a tilt by Brewster angle, 100% of horizontal polarization components P (hereinafter referred to as “P polarized light”) pass through the glass plate, and 85% of vertical polarization components S (hereinafter referred to as “S polarized light”) pass through the glass plate. Brewster angle means an incident angle of the light at which the reflection coefficient of P polarized light becomes zero. Therefore, it is possible to increase a ratio of the P polarized light to the S polarized light of the light passing through the glass plate, by disposing a plurality of glass plates in parallel with each other at an interval as shown in FIG. 3, and entering the light to the glass plates at a tilt by Brewster angle. Utilizing the above-mentioned principle, it is possible to constitute the polarizer by disposing a plurality of glass plates in parallel with each other at an interval and tilting these glass plates by Brewster angle relative to the parallel light. The light irradiation apparatus of the present invention is also provided with: a substrate transportation device 5 (not shown in FIG. 2) for a movement 6 of the irradiation target substrate in a direction 12 perpendicular to a straight line 11 including a projection image 9, which is obtained by projecting an incident plane 8 of the light entering at Brewster angle, i.e. the center part 7a of the projection light onto the substrate 4.

In FIG. 1 and FIG. 2, the light emitted from the light source 1 is collected by the projection device 2 for projecting the light from the light source where the collected light becomes a projection light including a non-parallel light, and then introduced to the polarizer 3. Since the polarizer 3 passes the P polarized light therethrough and reflects a major part of the S polarized light as described above, the light emitted from the polarizer 3 comprises almost the P polarized light.

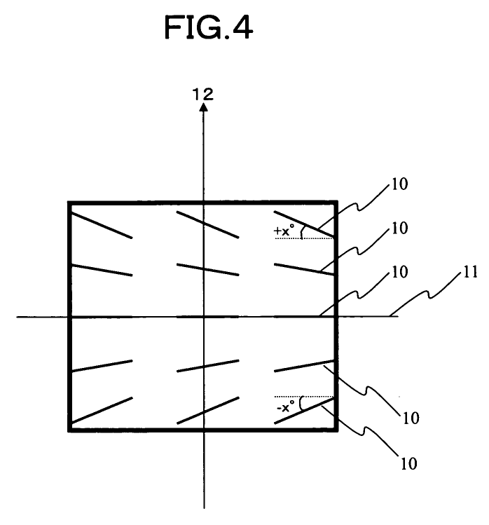

In the present invention, since the projection light 7 including a non-parallel light diverging in a certain range enters the polarizer 3, the distribution of the polarization axes 10 (directions of projection images of incident planes of light beams) of the P polarized light emitted from the polarizer 3 is symmetric relative to the straight line 11 including the projection images, onto the substrate, of the incident planes of the light entering at Brewster angle, as shown in FIG. 4.

In the present invention, it is possible to irradiate the substrate with the P polarized light, while the alignment film is transported by the substrate transportation device 5 in a direction 12 perpendicular to the straight line which includes the projection images and becomes the symmetry axis. Thereby, it is possible to realize a photo-alignment in a direction of the projection images, onto the substrate, of the incident planes of the center of the range in which the polarization axes diverge, i.e. the incident planes of the light entering at Brewster angle, by almost equalizing the accumulated irradiation dose of the prior irradiation with the accumulated irradiation dose of the posterior irradiation at any point in the irradiation target region on the irradiation target substrate. In this context, the prior irradiation means the irradiation before reaching the straight line 11 including the projection images onto the substrate, and the posterior irradiation means the irradiation after reaching the straight line 11.

The alignment direction of the alignment film depends on a direction of the polarization axis. In this embodiment, however, with regard to a point on the substrate to be moved, the irradiation is carried out for example so that a polarized light having a polarization axis tilted by −x° relative to the straight line including the projection images onto the substrate during the posterior irradiation is counterbalanced by a polarized light having a polarization axis tilted by +x° relative to the straight line including the projection images onto the substrate during the posterior irradiation. Thereby, it become possible to direct the alignment direction of the alignment film in a direction of the projection images, onto the substrate, of the incident planes of the center of the region in which the polarization axes diverge, i.e. the light entering at Brewster angle, so that the deviation of the alignment direction of the alignment film becomes small. The deviation of the alignment direction of the alignment film is preferably within ±0.5 degrees. The expression “almost equalizing the accumulated irradiation dose during the prior irradiation with the accumulated irradiation dose during the posterior irradiation at any point” means that the accumulated irradiation dose values of the prior irradiation and the posterior irradiation do not need to completely correspond to each other, insofar as the deviation of the alignment direction of the alignment film is within ±0.5°. In other words, it means that the two values can be different within the above-mentioned deviation range. The extent of the deviation of the alignment direction of the alignment film can be estimated by aligning liquid crystal molecules on the alignment film and estimating the extent of the deviation of the alignment direction of the liquid crystal molecules by means of a retardation measurement system, for example.

Therefore, in order to almost equalize the accumulated irradiation dose during the prior irradiation with the accumulated irradiation dose during the posterior irradiation at any point in the irradiation target region on the irradiation target substrate, the polarized light irradiation apparatus of the present invention is preferably provided with a control device for controlling conditions including the illuminance and the transportation or feed speed of the substrate at least.

In particular, it is preferable to irradiate the substrate with the light at a constant illuminance, and to transport the substrate at a constant speed. Because, in this case, it is relatively easy to almost equalize the accumulated irradiation dose during the prior irradiation with the accumulated irradiation dose during the posterior irradiation at any point in the irradiation target region on the irradiation target substrate. The expression “to irradiate the substrate with the light at a constant illuminance” means that the target substrate is irradiated with the polarized light having a uniform distribution of illuminance in the irradiation target region.

1. Light Source

The light source used in the present invention is not limited to any special one, insofar as it emits a light including any active light beam. For example, it may be a point light source, or may be a line light source. In particular, an ultraviolet light source such as ultrahigh pressure mercury lamp or a discharge lamp is advantageously used.

2. Projection Device

The projection device is not limited to any special one, insofar as it can project a light from the light source as a projection light including a non-parallel light as mentioned below. For example, it may be an ellipsoidal (spheroid or cylindroid) condensing mirror, a condensing lens, an integrator and so on.

In the present invention, “the projection light including a non-parallel light” means a light beam diverging to a certain extent in which the light beam passing through the polarizer based on the Brewster angle becomes a polarized light having an extinction ratio P/S (a ratio of P wave component to S wave component) allowing the photo-alignment of the alignment film. The extinction ratio P/S of the projection light including a non-parallel light in the present invention is preferably not less than 3, more preferably not less than 5. In the projection light including a non-parallel light, the light beam entering at Brewster angle preferably has an angle of divergence no more than 10 degrees, more preferably no more than 5 degrees.

3. Polarizer

The polarizer used in the present invention can be constituted by disposing only one transparent plate such as glass plate. However, it is usual that the polarizer is constituted from a plurality of glass plates 3a disposed in parallel with each other at a predetermined interval and at a tilt by Brewster angle (θ_{B}) relative to the incident direction of the center part 7a of the projection light, in order to obtain a sufficient extinction ratio. The glass plate to be used has preferably the high internal transmittance relative to an ultraviolet light having 365 nm wavelengths which greatly influence on the photo-alignment. Specifically, it is preferable to use a quartz glass having its internal transmittance no less than 98% relative to the ultraviolet light having 365 nm wavelengths. In particular, it is preferable to use a quartz plate. Furthermore, although it is usual to use the glass plate in a form of plane plate, it is also possible to use the glass plate in a form of non-plane plate such as a curved plate, depending on the required property of the irradiation light. In the present invention, it is sufficient to use a transparent plate which can utilize an effect of improving the extinction ratio of the P polarized light passing though the transparent plate at the Brewster angle of the light entering the transparent plate. Therefore, it is possible to use various transparent plates other than glass plates such as resin plates, transparent ceramic plates and fluorite plates.

The number of the glass plates to be disposed in parallel with each other is selected suitably depending on the required extinction ratio. In the case of the extinction ratio P/S is 5 (P:S=5:1), the number of the glass plates is preferably 10 to 15, more preferably 25 to 30.

4. Irradiation Target Substrate

The irradiation target substrate used in the present invention is provided with: a base plate made of glass or resin for example; and a photo-alignable film formed on the base plate. The irradiation target substrate may be one in which a drive element for driving the liquid crystal and/or a transparent electrode are formed on the substrate so as to obtain a liquid crystal driving electrode, and the photo-alignable film is further formed thereon, or may be one in which a light shielding film and/or a color filter are formed on the substrate, and the photo-alignable film is further formed thereon. Also, the irradiation target substrate may be one in which the photo-alignable film is formed on an long continuous transparent resin base plate. By forming the alignment film having an alignment ability on the long continuous transparent resin base plate and appropriately aligning the liquid crystal thereon, it is possible to obtain a retardation film. In this case, cellulose-based material such as triacetyl cellulose is preferably used as the long continuous transparent resin base plate. Particularly, the material for the alignment film will be discussed later in the following “C. Photo Alignment Film”, and the long continuous base material will be discussed later in the following “D. Retardation film”.

5. Substrate Transportation Device

The substrate transportation device used in the present invention is not limited to any special one, insofar as it can transport the irradiation target substrate in a direction perpendicular to the straight line including the projection image, onto the substrate, of the light entering at Brewster angle. It can be selected in accordance with the shape of the irradiation target substrate. For example, if the irradiation target substrate has a shape of a predetermined sized substrate such as a liquid crystal display device, a monoaxial transfer stage, an orthogonal biaxial transfer stage or the like can be used as the transportation device for transporting the substrate in a long continuous direction.

If the irradiation target substrate is an long continuous substrate, a web coater or the like can be used as a device for transporting the substrate in the long continuous direction.

6. Control Device

The control device used in the present invention is a control device for controlling conditions including at least the illuminance and the substrate feed rate, in order to almost equalizing the accumulated irradiation dose during the prior irradiation and the accumulated irradiation dose during the posterior irradiation at any point. The control device according to the present invention is for controlling the operation process and provided with: at least an input device by which a condition setting can be inputted; and a transmitting unit for transmitting a control signal to each driving device. The control device may be united with the light source or the substrate transport device, or may be independently disposed. Furthermore, a plurality of control devices may be disposed.

The input device is a device for inputting an instruction of start and stop, or an instruction about the operation condition, required for controlling the conditions including at least the illuminance and the substrate feed rate, and then converting it to a signal (generating an instruction signal), and transmitting the instruction signal to a control unit or the transmitting unit.

The input device is provided with: an interface part for inputting an instruction; a conversion part for converting the inputted instruction to a signal; and a transmittance part for transmitting the generated instruction signal to the control unit or the transmitting unit. The input device may be further provided with other components such as a program memory part for accumulating signals for automatic operation and transmitting a part of the accumulated signal at an appropriate time point.

The control unit may be provided with: a programming part for accumulating the control program; and a processing part for judging the adequacy of the operation condition or determining the optimum condition by comparing the instruction signal from the input device or the feedback information from various sensors with the control program.

The control device is further provided with: a transmitting unit for transmitting the control signal to various driving devices; and other components as occasion demands.

B. Polarized Light Irradiation Method

The polarized light irradiation method of the present invention is provided with:

a) a process of preparing a light source;

b) a process of preparing a projection device for projecting a light from the light source as a projection light including a non-parallel light;

c) a process of preparing a polarizer for passing the projection light therethrough and comprising one glass plate disposed at a tilt by Brewster angle relative to an incident direction of a center part of the projection light, or comprising a plurality of glass plates disposed in parallel with each other at a predetermined interval and at a tilt by Brewster angle relative to the incident direction of the center part of the projection light;

d) a process of preparing an irradiation target substrate; and

e) a process of irradiating the irradiation target substrate with a polarized light obtained by passing the projection light through the polarizer, while the subject as the irradiation target is transported in a direction perpendicular to a straight line including a projection image which is obtained by projecting an incident plane of a light entering at the Brewster angle among the projection light onto the substrate.

According to the polarized light irradiation method of the present invention, the irradiation target substrate is irradiated with the polarized light obtained by passing the projection light through the polarizer, while the irradiation target substrate is transported in a direction perpendicular to the straight line including the projection image, onto the substrate, of the incident plane of the light entering at Brewster angle. Thereby, even if the polarized light having the symmetrically diverged polarization axes, which is obtained by passing the projection light including a non-parallel light through the polarizer comprising a plurality of transparent plates disposed in parallel with each other at a tilt by Brewster angle, is used, it is possible to counterbalance the symmetrical distribution of the polarization axes as mentioned above, so that the alignment ability is uniformly provided for the alignment film. Furthermore, according to the method of the present invention, it is possible to conduct the photo-alignment efficiently in a large area, and it is possible also to provide the constant alignment ability continuously for the long continuous substrate without using a highly parallelized light. Furthermore, the method of the present invention is advantageous in view of process because of its simplicity, since there is no need to use the highly parallelized light.

As for the processes, i.e. a) a process of preparing a light source, b) a process of preparing a projection device for projecting light from the light source as a projection light including a non-parallel light, c) a process of preparing a polarizer, for passing the projection light therethrough, comprising one or a plurality of glass plates disposed in parallel with each other at a predetermined interval and at a tilt by Brewster angle relative to an incident direction of a center part of the projection light, and d) a process of preparing an irradiation target substrate, it is sufficient to prepare those explained in the above-described “A. Polarized Light Irradiation Apparatus”. Thus, the explanation will not be repeated.

As for the process, i.e.e) a process of irradiating the irradiation target substrate with the polarized light obtained by passing the projection light including a non-parallel light through the polarizer, while the irradiation target substrate is transported in a direction perpendicular to the straight line including a projection image which is obtained by projecting an incident plane of a light entering at the Brewster angle onto the substrate, it is sufficient to use the substrate transportation device appropriately selected in accordance with the shape of the irradiation target substrate, which has been explained in “A. Polarized Light Irradiation Apparatus”, and transport the irradiation target substrate in a direction perpendicular to the straight line including the projection image which is obtained by projecting an incident plane of the light entering at the Brewster angle onto the substrate.

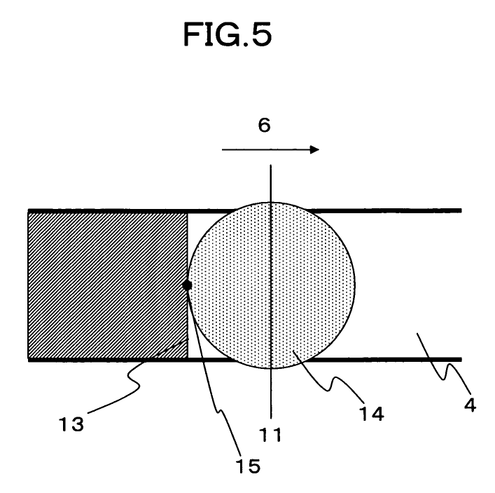

In the process e), it is preferable to irradiate the irradiation target substrate in such a manner that the accumulated irradiation dose during the prior irradiation is almost the same as the accumulated irradiation dose during the posterior irradiation at any point in an irradiation target region on the irradiation target substrate, provided that the prior irradiation refers to an irradiation before reaching the straight line including the projection image onto the substrate, and the posterior refers to an irradiation after reaching the straight line. Because in this case, it is possible to conduct the photo-alignment in a direction of the projection image which is obtained by projecting the incident plane of the light entering at the Brewster angle (i.e. the center of the range in which the polarization axes diverge) onto the substrate, as mentioned above. The irradiation target substrate is irradiated in such a manner that the accumulated irradiation dose during the prior irradiation is almost the same as the accumulated irradiation dose during the posterior irradiation, as for a whole region to be provided with the alignment ability. Therefore, as shown in FIG. 5, an irradiation start point of the edge 13 of the area of the substrate to be provided with the alignment ability should be the uppermost stream 15 of the region 14 capable of being irradiated with the polarized light. In this case, the condition is preferably is set by means of the control device as mentioned above.

Also, in the process e), it is preferable to irradiate the substrate at a constant illuminance, while transporting the substrate almost at a constant speed. Because in this case, it is easy to photo-align an entire alignable film more uniformly in a direction of the projection image which is obtained by projecting the incident plane of the light entering at the Brewster angle (i.e. the center of the range in which the polarization axes diverge) onto the substrate.

C. Photo Alignment Film

The photo alignment film according to the present invention is a photo-aligned film produced by means of the above-mentioned polarized light irradiation apparatus according to the present invention or by means of the above-mentioned polarized light irradiation method according to the present invention. The photo alignment film of the present invention is advantageous, in view of process, in that it can be provided with the uniform alignment ability without using the highly parallelized light and it has inherently no problem involved in a rubbing process such as a generation of static electricity due to triboelectrification or a generation of dust from cloths or the like, since it is produced on the basis of the photo-alignment of the photo-alignable materials by means of the polarized light irradiation apparatus according to the present invention or by means of the polarized light irradiation method according to the present invention.

The photo alignment film according to the present invention may be one formed on an liquid crystal driving electrode in which a drive element for driving the liquid crystal and/or a transparent electrode film are formed on the substrate, or may be one formed on a light shield film and/or a color filter formed on the substrate. Also, it may be one formed on an long continuous resin substrate.

The photo alignment film according to the present invention is formed from a photo-alignable material capable of being provided with the alignment ability by photoisomerization or photodimerization at least.

The photo-alignable material is not limited to any special one.

For example, it may be one obtained by photoisomerizing azobenzene group or the like, or one obtained by photodimerizing cinnamoyl group, coumarin group, chalcone group, benzophenone group or the like, or one obtained by photolyzing polyimide resin or the like. As for the photo-alignable material utilizing these photoisomerization, photodimerization or photolysis, it is often to use a high molecular compound such as polymer so as to obtain a uniform film when applied onto the substrate such as a glass substrate. It is also often that a photo-alignable constitutional unit such as azobenzene group or cinnamoyl group is introduced into such a high molecular compound as its main chain or side chain. Also, there is a case that a photo-alignable molecule as a guest molecule is dispersed into a polymer compound as a host compound.

Also, it is possible to use a resin containing a photoisomerizable and dichroic structural unit and a reactive functional group, as disclosed in WO 9637807 official gazette. Furthermore, the photo-alignable material may be one utilizing a compound having a maleimide group which is a photo-polymerizable group without any polymerization initiator, as disclosed in Japanese Patent Application Laid-open No. 2000-53766, Japanese Patent publication No. 2962473, or Japanese Patent Application Laid-open No. 2002-265422.

D. Retardation Film

The present invention also provides a retardation film produced by means of the above-mentioned polarized light irradiation apparatus according to the present invention or by means of the above-mentioned polarized light irradiation method according to the present invention. The retardation film of the present invention is provided with a photo alignment film produced by photo-aligning the photo-alignable material by means of the above-mentioned polarized light irradiation apparatus according to the present invention or by means of the above-mentioned polarized light irradiation method according to the present invention. Thereby, the retardation film of the present invention is advantageous, in view of process, in that it can be uniformly aligned and thereby have uniform optical property without using the highly parallelized light and it has inherently no problem involved in a rubbing process such as a generation of static electricity due to triboelectrification or a generation of dust from cloths or the like. Even if the retardation film has an long continuous shape, it can be provided with a constant alignment ability continuously, and can be produced efficiently, without using the highly parallelized light.

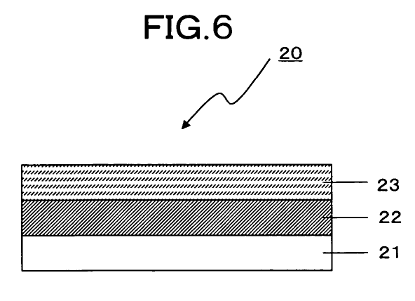

FIG. 6 illustrates an example of the layer structure of the retardation film 20 of the present invention. In FIG. 6, a reference numeral 21 denotes a resin substrate, a reference numeral 22 denotes a photo alignment film formed on the resin substrate 21, and a reference numeral 23 denotes a retardation layer formed on the photo alignment film 22.

1. Resin Substrate

A type of the resin substrate is determined in correspondence with an intended application of the retardation film. In the case that the retardation film is intended to be used as an optically compensating sheet such as a retardation plate, a polarizer and a color filter of a display device, a transparent resin substrate is used as the resin substrate. In this context, “transparent” means that the light transmission is not less than 80%.

Examples of such a transparent resin substrate material include: cellulose based polymers; norbornene based polymers such as one known under the commercial name ARTON available from JSR Corporation or the commercial name ZEONEX available from ZEON CORPORATIONS; cycloolefin based polymers such as one known under the commercial name ZEONOR available from ZEON CORPORATIONS; and polymethlmethacrylate. As the cellulose based polymers, a cellulose ester and cellulose acetate are preferable, such as diacetyl cellulose and triacetyl cellulose.

The thickness of the resin substrate is preferably 20 μm to 500 μm, more preferably 50 μm to 200 μm. In order to improve the adhesiveness between the resin substrate and the photo alignment film formed thereon, it is possible that the resin substrate is subjected to a suitable surface treatment (e.g. saponification treatment, glow discharge treatment, corona discharge treatment, ultraviolet ray (UV) treatment, flame treatment), or it is possible that a primer layer (adhesive layer) is formed on the resin substrate.

2. Photo Alignment Film

The photo alignment film used for the retardation film according to the present invention is a photo-aligned film produced by photo-aligning the photo-alignable material by means of the above-mentioned polarized light irradiation apparatus or method according to the present invention. Therefore, it is possible that the photo alignment film is formed by applying the photo-alignable material the same as that described in “C. Photo Alignment Film” onto the substrate and then drying to form the applied film, and then providing for it the photo-alignment ability by means of the above-mentioned polarized light irradiation apparatus or method according to the present invention.

3. Retardation Layer

As the retardation layer, it is possible to use a nematic liquid crystal or a cholesteric liquid crystal. Such a material is not limited to any special kind insofar as it is a liquid crystal material capable of forming a liquid crystal having a nematic order, a smectic order or a cholesteric order, when the retardation layer is formed from these materials only. It may be a polymer liquid crystal or may be a polymerizable liquid crystal compound. In the case of the polymerizable liquid crystal compound, it is preferable that it has polymerizable functional groups at both ends of its molecule, in order to obtain an optical element having a good heat resistance. The retardation layer may be made of two or more stacked layers.

Also, the retardation layer may be made of a chiral nematic liquid crystal which has a cholesteric order and is obtained by adding a chiral agent to a nematic liquid crystal. The chiral agent means a low molecular compound having an optically active site and having the molecular weight no more than 1500. The chiral agent is used mainly for inducing a helix pitch in the positive uniaxial nematic order.

When the liquid crystal polymer is used, the retardation layer can be obtained by applying a solution, which is obtained by dissolving the liquid crystal polymer and other components in a solvent, onto the photo alignment film, then drying it, then heating it to a liquid crystal phase forming temperature, and then cooling it while maintaining the aligned status. Alternatively, the retardation layer can be obtained by applying a solution, which is obtained by dissolving the polymerizable liquid crystal compound and other components (e.g. polymerizable monomer, photopolymerization initiator) in a solvent, onto the photo alignment film, then drying it, then heating it to a liquid crystal phase forming temperature, then irradiating it with LW or an electron beam so as to polymerize it, and then cooling it.

The retardation layer may be made of two or more liquid crystal layers. A plurality of layers may be made of liquid crystal layers of the same kind, or may be made of liquid crystal layers of different kind selected from the nematic order, the smectic order or the cholesteric order.

It is possible to add a surfactant, a polymerizable monomer (e.g. a compound having vinyl group, vinyloxy group, acryloyl group and methacryloyl group), polymer and so on to the coating liquid for forming the retardation layer, in addition to the liquid crystal compound, the chiral agent (if needed) and the photopolymerization initiator (if needed), insofar as it does not inhibit the alignment of the liquid crystal compound. It is possible to control a tilt angle of the liquid crystal at the surface side (air side) by selecting these surfactant, polymerizable monomer and polymer.

As explained above, the polarized light irradiation apparatus and method according to the present invention enable to provide a uniform alignment ability for the photo alignment film without using the highly parallelized light, and enable to conduct the photo-alignment efficiently in a large area, and enable to realize an excellent durability. The polarized light irradiation apparatus and method according to the present invention are advantageous in view of simple device and process, since it does not need to use the highly parallelized light. The apparatus and method according to the present invention enable to provide a constant alignment ability continuously for an long continuous-shaped substrate without using the highly parallelized light. Furthermore, the apparatus and method according to the present invention enable to downsize the apparatus in comparison with the prior art, even for conducting the photo-alignment in a large area.

The photo alignment film is advantageous, in view of process, in that it can be provided with the uniform alignment ability without using the highly parallelized light and it has inherently no problem involved in a rubbing process such as a generation of static electricity due to triboelectrification or a generation of dust from cloths or the like.

Furthermore, the retardation film of the present invention is advantageous, in view of process, in that it can be uniformly alignmed and thereby have the uniform optical property without using the highly parallelized light and it has inherently no problem involved in a rubbing process such as a generation of static electricity due to triboelectrification or a generation of dust from cloths or the like.

The present invention may not be limited to the above-mentioned embodiments. The embodiments are given solely for the purpose of illustration. Any invention which has the substantially same constitution as the technical idea mentioned in claims of the present invention and has the same operation and effect as the present invention is within the scope of the present invention.

### EXAMPLES

The present invention will now be specifically discussed with reference to some Examples.

### Example 1

A ultraviolet (hereinafter referred to as LW) light source using a high pressure mercury lamp (TOSCURE 751 available from HARISON TOSHIBA LIGHTING Corp.) was used as a light source. A projection light including a non-parallel light formed by means of this light source and an ellipsoidal condenser mirror was entered a polarizer made of 25 quartz plates disposed in parallel with each other at a predetermined interval so that a center part of the projection light including a non-parallel light enters from a direction of Brewster angle. A divergence angle of the projection light from the light source was about 10 degrees. The polarization axis on the substrate had an angle −7 degrees at the uppermost stream of the irradiation region and an angle +7 degrees at the lowermost stream, provided that the center part, which was to be a straight line including a projection image onto the substrate of an incident plane of the light entering at Brewster angle, has an angle 0 degree. The extinction ratio was 16/1 (i.e. “16:1”) at the center part of the irradiation region and was 5/1 (i.e. “5:1”) at the edge of the irradiation region. The illuminance distribution was a constant within the irradiation region. The irradiation region was of 400 mm square. The illuminance of the light source was controlled so that the exposure was 10 mJ/cm² when the substrate feed speed was 5 m/min. The polarized UV irradiation was conducted while an long continuous substrate on which the alignable film layer was formed was transported at a speed 5 m/min in a direction perpendicular to the straight line including the projection image, onto the substrate, of the incident plane of the light entering at Brewster angle. The entire irradiation region was about 10 m in an long continuous direction (feed direction) and about 400 mm in a width direction.

The long continuous substrate on which the alignable film was formed was prepared by applying a photo-alignable material onto an long continuous-shaped triacetyl cellulose film and then drying to form the alignable film.

The alignment film provided with the alignment ability by the above-mentioned processes was coated with a nematic liquid crystal material of about 1 μm, resulting in the retardation film of 100 nm thickness and having the phase difference.

The alignment angle of the obtained retardation film was measured by means of a retardation measurement system known under the commercial name RETS-1250V available from Otsuka Electronics Co.,Ltd. for each predetermined interval (1 m each in an long continuous direction, 150 mm each in a width direction). As the result, the deviation of the alignment angle was within ±0.5 degrees in both the long continuous direction and the width direction. This means that the value of the phase difference had no significant deviation.

### Comparative Example 1

The substrate was irradiated with the polarized UV light to form an alignment film in the same condition as Example 1 except that the substrate on which the alignable film was formed was not transported. The entire irradiation region was about 400 mm square. In a similar manner as Example 1, the substrate was coated with the nematic liquid crystal material of about 1 μm, resulting in the retardation film of 100 nm thickness and having the phase difference.

The alignment angle of the obtained retardation film was measured by means of a retardation measurement system known under the commercial name RETS-1250V available from Otsuka Electronics Co.,Ltd. for each predetermined interval (150 mm each in an long continuous direction, 150 mm each in a width direction). As the result, the deviation of the alignment angle was −7 degree at the upper stream and +7 degree at the lower stream relative to the center part of the irradiation region. This means that the deviation of the alignment angle became large in the long continuous direction of the retardation film.

### Comparative Example 2

The substrate was irradiated with the polarized LW light to form an alignment film in the same condition as Example 1 except that the ellipsoidal condenser mirror was not used and thereby the light was used as a diffusion light. In a similar manner as Example 1, the substrate was coated with the nematic liquid crystal material of about 1 μm. However, it was not possible to align the liquid crystal material.

The extinction ratio was about 16/1 (i.e. 16:1) at the center part of the irradiation region, and about 1/1 (i.e. 1:1) at the edge of the irradiation region.

What is claimed is:

1. A polarized light irradiation apparatus comprising:
a light source;
a projection device for projecting a light from the light source as a projection light including a non-parallel light;
a polarizer for passing the projection light therethrough and comprising one glass plate disposed at a tilt by Brewster angle relative to an incident direction of a center part of the projection light, or comprising a plurality of glass plates disposed in parallel with each other at a predetermined interval and at a tilt by Brewster angle relative to the incident direction of the center part of the projection light; and
a substrate transportation device for transporting an irradiation target substrate in a direction perpendicular to a straight line including a projection image which is obtained by projecting an incident plane of a light entering at the Brewster angle among the projection light onto the substrate.

2. The polarized light irradiation apparatus according to claim 1, further comprising a control device for controlling conditions including an illuminance and a transportation speed at least, in order to substantially equalize an accumulated irradiation dose during a prior irradiation with an accumulated irradiation dose during a posterior irradiation at any point in an irradiation target region on the irradiation target substrate, provided that the prior irradiation refers to an irradiation before reaching the straight line including the projection image onto the substrate and the posterior irradiation refers to an irradiation after reaching the straight line.

3. The polarized light irradiation apparatus according to claim 1, wherein the subject as the irradiation target is irradiated at a constant illuminance and is transported almost at a constant speed.

4. The polarized light irradiation apparatus according to claim 1, wherein the irradiation target substrate has an long continuous shape.

5. A polarized light irradiation method comprising:
a) a process of preparing a light source;
b) a process of preparing a projection device for projecting a light from the light source as a projection light including a non-parallel light;
c) a process of preparing a polarizer for passing the projection light therethrough and comprising one glass plate disposed at a tilt by Brewster angle relative to an incident direction of a center part of the projection light, or comprising a plurality of glass plates disposed in parallel with each other at a predetermined interval and at a tilt by Brewster angle relative to the incident direction of the center part of the projection light;
d) a process of preparing an irradiation target substrate; and
e) a process of irradiating the irradiation target substrate with a polarized light obtained by passing the projection light through the polarizer, while the subject as the irradiation target is transported in a direction perpendicular to a straight line including a projection image which is obtained by projecting an incident plane of a light entering at the Brewster angle among the projection light onto the substrate.

6. The polarized light irradiation method according to claim 5, wherein
in the process e), the irradiation is conducted so as to substantially equalize an accumulated irradiation dose during a prior irradiation with an accumulated irradiation dose during a posterior irradiation at any point in an irradiation target region on the irradiation target substrate, provided that the prior irradiation refers to an irradiation before reaching the straight line including the projection image onto the substrate and the posterior irradiation refers to an irradiation after reaching the straight line.

7. The polarized light irradiation method according to claim 5, wherein
in the process e), the substrate is irradiated at a constant illuminance, while the substrate is transported almost at a constant speed.

8. The polarized light irradiation method according to claim 5, wherein
the irradiation target substrate has an long continuous shape.

9. A photo alignment film produced by means of the polarized light irradiation apparatus according to claim 1.

10. A photo alignment film produced by means of the polarized light irradiation method according to claim 5.

11. A retardation film produced by means of the polarized light irradiation apparatus according to claim 1.

12. A retardation film produced by means of the polarized light irradiation method according to claim 5.
